(19) United States
(12) Patent Application Publication
(10) Pub. No.: US 2015/0112687 A1
(43) Pub. Date: Apr. 23, 2015

(54) METHOD FOR RERECORDING AUDIO MATERIALS AND DEVICE FOR IMPLEMENTATION THEREOF

(71) Applicant: Aleksandr Yurevich BREDIKHIN, Moscow (RU)

(72) Inventor: Aleksandr Yurevich Bredikhin, Moscow (RU)

(21) Appl. No.: 14/402,084

(22) PCT Filed: May 16, 2013
(86) PCT No.: PCT/RU2013/000404

§ 371 Date: Nov. 18, 2014

(30) Foreign Application Priority Data
May 18, 2012 (RU) 2012120562

(51) Int. Cl. G10L 13/02

(52) U.S. Cl. CPC G10L 13/02
USPC 704/260

(57) ABSTRACT

The inventive method and apparatus improve the quality of the teaching phase, improve a degree of match of the user's voice in a converted speech signal, and ensure the possibility of carrying out the teaching phase only once for different audio materials. A program-controlled electronic information processing device (PCEIPD) generates an acoustic base of initial audio materials (ABIA) and an acoustic teaching base (ATB). Upon selecting at least one audio material from the ABIA list, this material is transmitted to the PCEIPD RAM for storage. Files are selected from the ΔTB of the speaker's teaching phrases, and are converted into audio phrases transmitted to a sound playback device. The user repeats audio phrases into a microphone, and the text of a repeated phrase and a cursor moves along the phrase text in accordance with how the user should repeat the phrase.

The invention relates to electronic engineering, primarily with the use of program-controlled electronic devices for information processing, and may be used in speech synthesis.

A device for detecting and correcting accent is known that comprises: (a) means for inputting unwanted speech patterns, wherein said speech patterns are digitized, analyzed, and stored in a digital memory library of unwanted speech patterns; (b) means for inputting desired speech patterns positively corresponding to said unwanted speech patterns, wherein said desired speech patterns are digitized, analyzed, and stored in a digital memory library of desired speech patterns; (c) means for actively recognizing incoming speech patterns, comparing said recognized speech patterns with unwanted speech patterns stored in digital memory as a library of unwanted speech patterns, and removing and queuing for replacement of unwanted speech patterns detected in said incoming speech patterns; (d) means for analyzing said unwanted speech patterns detected in incoming speech patterns and determining desired speech patterns positively relating thereto; and (e) means for substituting said desired speech patterns, which are recognized as positively corresponding to said unwanted speech patterns, and obtaining output speech patterns wherein said unwanted speech patterns are removed and replaced by said correct speech patterns. (US Patent Application No. 20070038455, G10L 13/00, publ. Feb. 15, 2007).

This device analyzes input audio signal for pre-specified unwanted speech patterns, i.e., phonemes or phoneme groups that need to be corrected, for example being a foreign accent. These unwanted patterns are then changed or completely replaced with pre-stored sound patterns adjusted for timbre of the user's voice. A level of speech adjustment may be preset as necessary. The device works in two modes: the first is the learning mode, i.e. storing unwanted phonemes and sound patterns for their replacement, and the second is the correction mode, i.e. phoneme modifications on the basis of stored information. The implementation is software and computer-based hardware. The hardware apparatus is based on parallel signal processing and therefore allows for real-time accent correcting of variable complexity, up to multiple-user multiple-accent super-complex systems based on mesh architecture of multiple chips and boards.

A limitation of this device is the possibility of using it for correcting unwanted phonemes and the impossibility of adjusting other speech characteristics, such as modifying voice timbre.

A voice processing apparatus is known that modulates an input voice signal into an output voice signal, the apparatus comprising: an input device that inputs an audio signal which represents an input voice having a frequency spectrum specific to the input voice; a processor device that is configured to process the audio signal for modifying the frequency spectrum of the input voice signal; a parameter table is provided for storing a plurality of parameter sets, each of which differently characterizes modification of the frequency spectrum by the audio signal processor. A CPU selects a desired one of the parameter sets from the parameter table, and configures the audio signal processor by the selected parameter set. A loudspeaker outputs the audio signal which is processed by the audio signal processor and which represents an output voice characterized by the selected parameter set. (U.S. Pat. No. 5,847,303, G10H 1/36, publ. Dec. 8, 1998).

This apparatus may be used for converting a frequency range, thus enabling men to sing by a woman's voice, and vice versa. Furthermore, the apparatus enables to sing a karaoke song by the voice of a selected professional singer due to modifying a frequency spectrum. Thus, the apparatus enables to change speech characteristics in accordance with a set of pre-determined parameters stored in a data base of a computing device, such as a computer.

Limitations of this apparatus are: a voice signal may be converted only into a pre-determined voice signal characterized by parameters pre-stored in a data base; it is impossible to playback a modified voice signal in another spatial point, since the apparatus is designed for the use in a karaoke only; the apparatus may be used in the real-time mode only by one user.

A device for conversion of an input voice signal into an output voice signal in compliance with a target voice signal is known that comprises a source of incoming sound signal, a memory device that temporarily stores initial data being compared to and taken from a target voice, an analyzing device that analyzes an incoming voice signal and extracts a number of incoming data frames representing the incoming voice signal, a producing device that produces a number of target data frames representing a target voice signal based on the initial data by correcting the target data frames relative to the incoming data frames, and a synthesizing device that synthesizes an output voice signal in accordance with the target data frames and the incoming data frames, the producing device being constructed on the basis of a characteristic analyzer that is made so as to ensure extraction of a characteristic vector being the characteristic of the output voice signal from the incoming voice signal and on the basis of a correcting processor, wherein the memory device stores data on characteristic vectors in order to use them for recognizing such vectors in incoming voice signals and stores the conversion function data being a part of the initial data and representing a characteristic of target behavior of a voice signal, the correcting processor detects characteristic vector recognition data and the conversion function data relative to output correction data corresponding to information on timbre of the output correction data, information on an amplitude of the target behavior data and information on a shape of a characteristic vector enveloping spectrum; the analyzing device, the characteristic analyzer, the correcting processor and the synthesizing device being connected in series, the characteristic vector data output of the memory device being connected to the characteristic analyzer data input, and the conversion function data output of the memory device being connected to the data input of the correcting processor; the device is provided with a switch for the learning/operation modes and an incoming signal analyzer, the source of an incoming sound signal is connected to the input of the switch for the learning/operation modes, the memory device is provided with a phonogram unit ensuring storage of database of professional performer phonograms, the input/output of the switch for the learning/operation modes is connected to the input/output of the incoming signal analyzer, and its output is connected to the input of the phonogram unit of the memory device; the first data output of the phonogram unit is connected to the input of the incoming signal analyzer, and the second data output of the phonogram unit is connected to the input of the analyzing device; the incoming signal analyzer is made so as to ensure decomposition of the incoming voice signal received at its input/output through the switch for the learning/operation modes from an incoming voice signal source into signal sinusoidal components, signal noise components and signal residual components and is provided with the possibility of forming sets of characteristic vectors and conversion functions for each of the said components separately and their transfer to the memory device; the analyzing device is made so as to ensure decomposition of an incoming voice signal from the phonogram unit into signal sinusoidal components, signal noise components and signal residual components; and the characteristic analyzer and the correcting processor are provided with the possibility of processing the said components separately. (RU Patent No. 2393548, G10L13/00, publ. Jun. 27, 2010).

The device enables to ensure performance of a karaoke song by the user's voice, but in the manner and at a quality level of a professional singer (for example, not worse than a performance level of a known performer of a given song), while minimizing errors that may be made by the user during the course of performance.

A limitation of the device is the impossibility of monitoring the learning mode for the purpose of obtaining highest quality of playback in the operation mode.

A method of voice conversion is known that comprises the learning phase consisting in dynamically equalizing speech signals of the target and initial speakers, forming corresponding codebooks for speech signal display and conversion functions, as well as the conversion phase consisting in detecting parameters of an initial speaker speech signal, converting the parameters of the initial speaker speech signal into the speech signal parameters of the target speaker, and in synthesizing a converted speech signal, while at the learning phase fundamental tone harmonics, a noise component and a transitional component are picked up in the speech signal of the target and initial speakers in the analysis frame, a voiced frame of a speech signal being represented as fundamental tone harmonics and a noise component, and a transitional component consisting of non-voiced frames of a speech signal; the speech signal frame of the initial speaker is processed, and its voiceness is determined; if the speech signal frame is voiced, its fundamental tone frequency is determined; if no fundamental tone is detected, then the frame is a transitional one, and if the frame is not voiced and is not a transitional one, then the processed frame is represented as a silent interval in the speech signal; then a transitional frame is formed with the use of a linear predictor with excitation according to its codebook, coefficients for the linear predictor filter and parameters for the long-term filter of the linear predictor are determined, which afterwards are converted into the target speaker parameters, and a transitional frame of the target speaker is synthesized; during the conversion phase, if a speech signal frame of the initial speaker is voiced, the frequency of the fundamental tone of the speech signal and the time loop for its change are determined, and through discrete Fourier transformation that is matched to the fundamental tone frequency the speech signal frame of the initial speaker is subdivided into components, i.e. into frequency harmonics of the fundamental tone and a noise component equal to residual noise from the difference between the frame of the initial speaker and the frame re-synthesized on the fundamental tone harmonics; these components are converted on the basis of display codebooks into the target speaker parameters, while additionally taking into account conversion of the fundamental tone frequency for the initial speaker, the component of fundamental tone harmonics and the noise component of the target speaker are synthesized and then summed up with the synthesized transitional component and a silent interval in the speech signal. (RU Patent No. 2427044, G10L21/00, publ. Aug. 20, 2011).

This method enables to raise a degree of coincidence of the initial speaker voice in a converted speech signal due to improving intelligibility and recognizability of the voice of the target speaker.

A limitation of the known technical solution is that it is fully text-dependent, and it is impossible to control the learning process (phase) in order to playback a quality speech signal both before and after its conversion.

No analogous solutions as to the achieved technical effect have been identified during a patent search.

The objective of the invention is to improve quality and performance characteristics. The technical effect that may be obtained while implementing the claimed method and apparatus is quality improvement of the learning phase and its rate, improvement of match of the voice of a user (target speaker) in a converted speech signal due to improvement of accuracy, intelligibility and recognizability of the user's voice, provision of the possibility of carrying out the learning phase only once for a particular audio material and using this teaching phase data for re-sounding of other audio materials.

During the teaching phase, the claimed technical solution may use the following bases:
The universal base that is intended for re-sounding by the user's voice of any audio materials (audio books). That is, a user teaches a program-controlled electronic information processing device according to this base only once and then may re-sound any audio books without further teaching of the device. Thus, during next playback of audio materials text-independence is obtained.
A specialized base that is prepared by the program-controlled electronic information processing device for a specific totality of audio materials (that is, one base is needed for one group of audio books, and another base is needed for another group. Text-dependence).

In order to achieve the above objective with obtaining of the said technical effect, the method of re-sounding audio materials consists in that an acoustic base of initial audio materials is formed in the program-controlled electronic information processing device, the base comprising parametric files, and an acoustic teaching base is formed that comprises way-files of the speaker's teaching phrases and corresponds to the acoustic base of acoustic base of initial audio materials, data from the acoustic base of initial audio materials are transmitted for the purpose of displaying a list of initial audio materials on the monitor screen; if a user selects at least one audio material from the list of the acoustic base of initial audio materials, data on this material are transmitted into the random-access memory of the program-controlled electronic information processing device, and way-files of the speaker's teaching phrases are selected from the acoustic teaching base, which correspond to the selected audio material, the way-files being converted into audio phrases and transmitted to the user for playback; the user repeats these audio phrases into the microphone, during playback of which the monitor screen displays text of the played back phrase and a cursor that moves along the phrase text in accordance with how the user should repeat it; way-files are generated in accordance with the played back phrases and stored in an order of playing back the phrases in a formed acoustic base of the target speaker, the program-controlled electronic information processing device monitoring a rate and loudness of a repeated phrase; a conversion function file is formed from way-files stored in the target speaker acoustic base and way-files of the acoustic teaching base; then the parametric files of the acoustic base of initial audio materials are converted and transformed into a way-file for storing in the formed acoustic base of converted audio materials and providing converted audio materials to the user on the monitor screen.

Further embodiments of the method are possible, wherein it is expedient that
the user is also registered, when a remote server or a computer running in the multiuser mode is used as the controlled electronic information processing device;
before the user repeats voice phrases into the microphone, background noise is recorded, which record is stored as a way-file in the target speaker acoustic base, a program-controlled electronic information processing device reduces said background noise; —during controlling a rate of a repeated phrase, the program-controlled electronic information processing device filters a digital RAW-stream corresponding to the repeated phrase, instantaneous energy is calculated, and calculation results for said instantaneous energy is smoothed, a smoothed value of average energy is compared to a pre-set threshold value, average duration of silent intervals in the way-file is calculated, and the program-controlled electronic information processing device decides on compliance of the speech rate to the standard one;
during controlling a rate of a repeated phrase, the program-controlled electronic information processing device evaluates duration of syllabic segments; for this, a speech signal of the repeated phrase is normalized, filtered, detected, enveloping signals of the repeated phrase are multiplied, differentiated, an obtained signal of the repeated phrase is compared to threshold voltages, and a logic signal corresponding to the presence of a syllabic segment is extracted, duration of the syllabic segment is calculated; and the program-controlled electronic information processing device decides on compliance of the speech rate to the standard one;
during controlling loudness of a repeated phrase, the lower limit of the loudness range and the upper limit of the loudness range are set, loudness of the repeated phrase is compared to the loudness range limits, and, if loudness of the repeated phrase is beyond these range limits, the program-controlled electronic information processing device displays a message on violating loudness of the repeated phrase on the monitor screen;
after way-files are stored in the target speaker acoustic base and way-files are stored in the acoustic teaching base, the program-controlled electronic information processing device normalizes the way-files, cuts them, blanks noise and controls compliance between the played back and displayed text of the repeated phrase.

In order to achieve the above objective and obtain the said technical effect, the apparatus for re-sounding audio materials comprises a control unit, an audio material selection unit, an acoustic base of initial audio materials, an acoustic base of the target speaker, a teaching unit, a unit for phrase playback, a phrase recording unit, an acoustic teaching base, a conversion unit, a conversion function base, an acoustic base of converted audio materials, a unit for displaying conversion results, a monitor, a keyboard, a pointing device, a microphone, a sound playback device. The keyboard output is connected to the first input of the control unit, to the first input of the audio material selection unit, and to the first input of the unit for displaying conversion results, the output of the pointing device is connected to the second input of the control unit, to the second input of the audio material selection unit, and to the second input of the unit for displaying conversion results, the monitor input is connected to the output of the audio material selection unit, to the output of the teaching unit, to the first output of the unit for phrase playback, to the output of the unit for recording phrases, to the output of the conversion unit, to the output of the unit for displaying conversion results, the input of the sound playback device is connected to the second output of the unit for phrase playback, the microphone output is connected to the input of the unit for recording phrases, the first input/output of the control unit is connected to the first input/output of the audio material selection unit, the second input/output of the control unit—to the first input/output of the target speaker acoustic base, the third input/output of the control unit—to the first input/output of the teaching unit, the fourth input/output of the control unit—to the first input/output of the conversion unit, the fifth input/output of the control unit—to the first input/output of the unit for displaying conversion results, the second input/output of the audio material selection unit is connected to the first input/output of the acoustic base of initial audio materials, and the second input/output of the acoustic base of initial audio materials is connected to the fourth input/output of the conversion unit, the second input/output of the target speaker of the acoustic base is connected to the first input/output of the phrase recording unit, and the second input/output of the phrase recording unit—to the third input/output of the teaching unit, the second input/output of the teaching unit is connected to the first input/output of the unit for phrase playback, and the second input/output of the unit for phrase playback—to the input/output of the acoustic teaching base, the fourth input/output of the teaching unit is connected to the first input/output of the conversion function base, the second input/output of the base is connected to the second input/output of the conversion unit, the third input/output of the conversion unit is connected to the second input/output of the acoustic base of converted audio materials, and the first input/output of the acoustic base of converted audio materials is connected to the second input/output of the unit for displaying conversion results.

Another embodiment of the apparatus is possible, wherein it is expedient that the apparatus is provided with a authorization/registration unit and a base of registered users, the keyboard output is connected to the first input of the authorization/registration unit, and the pointing device output is connected to the second input of the authorization/registration unit, the monitor input is connected to the output of the authorization/registration unit, the sixth input/output of the control unit is connected to the first input/output of the authorization/registration unit, and the second input/output of the authorization/registration unit is connected to the input/output of the registered users base.

The above-described advantages of the claimed technical solution as well as its specific features are explained below on a preferred embodiment with reference to the accompanying drawings, wherein:

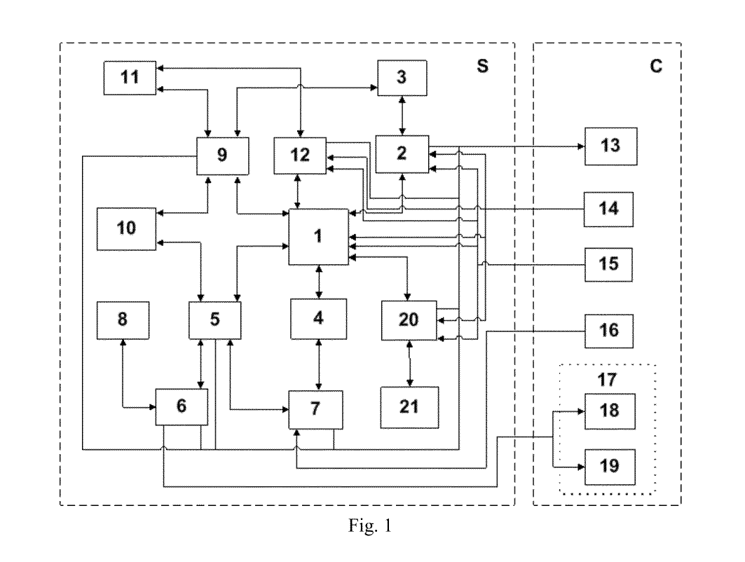

FIG. 1 shows the functional diagram of the claimed apparatus;

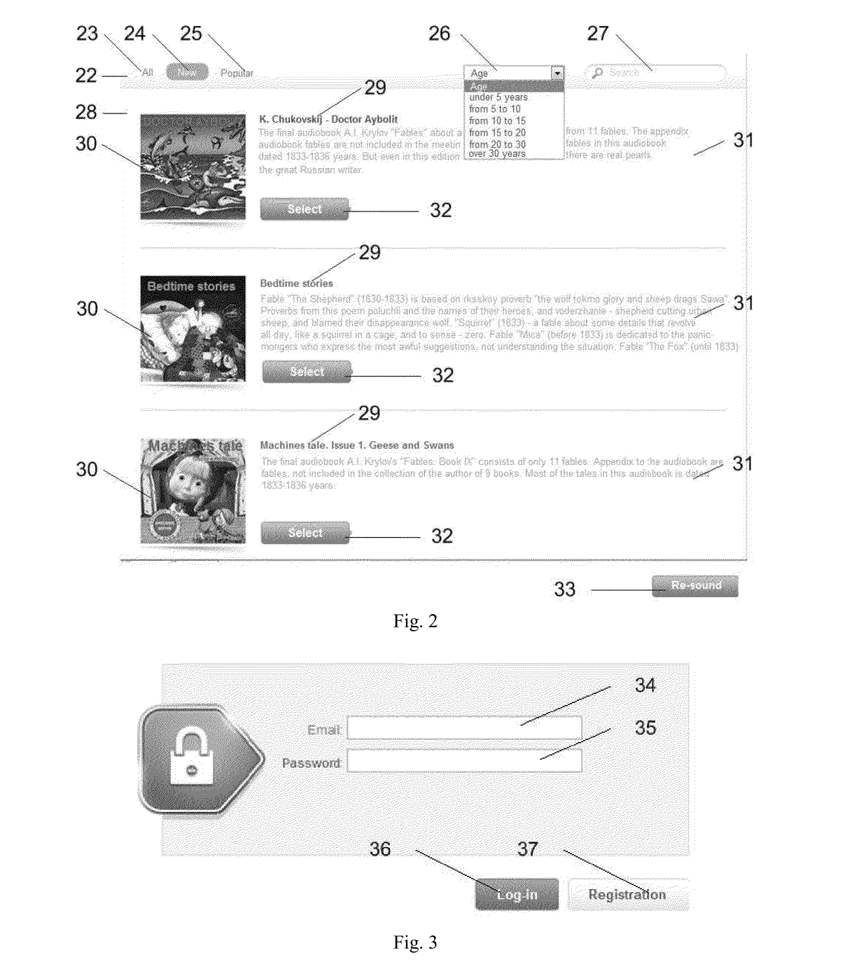

FIG. 2 shows the graphic interface of the audio material selection form;

FIG. 3 shows the graphic interface of the authorization/registration form;

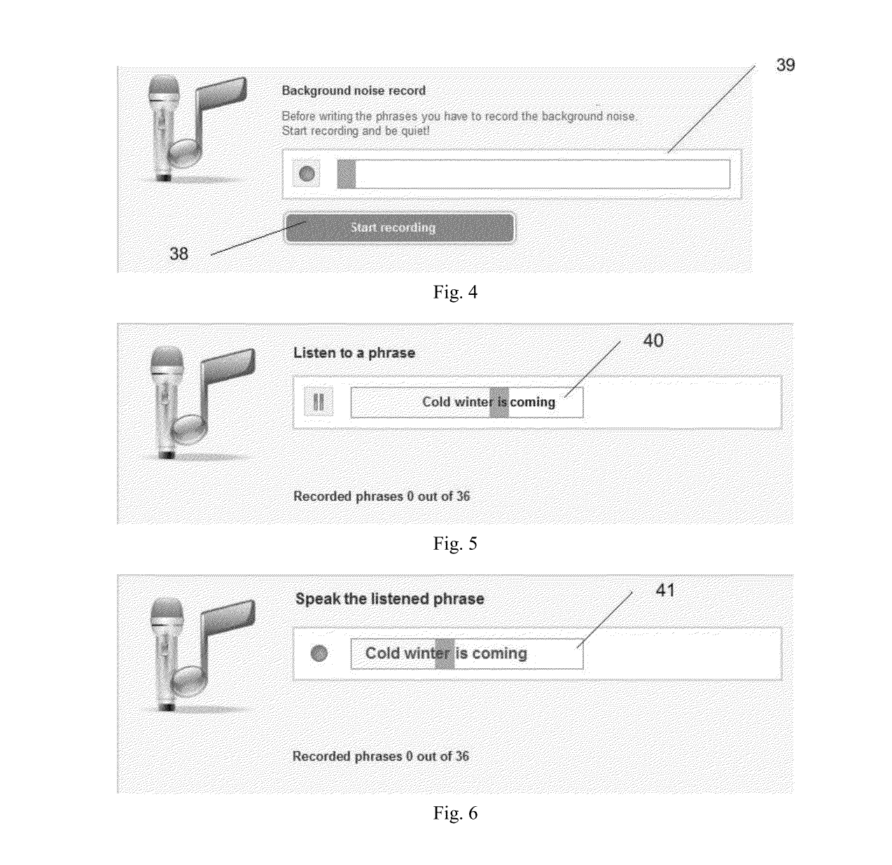

FIG. 4 shows the graphic interface of the background noise recording form;

FIG. 5 shows the graphic interface of the phrase playback form;

FIG. 6 shows the graphic interface of the playback (recording) form for a listened phrase;

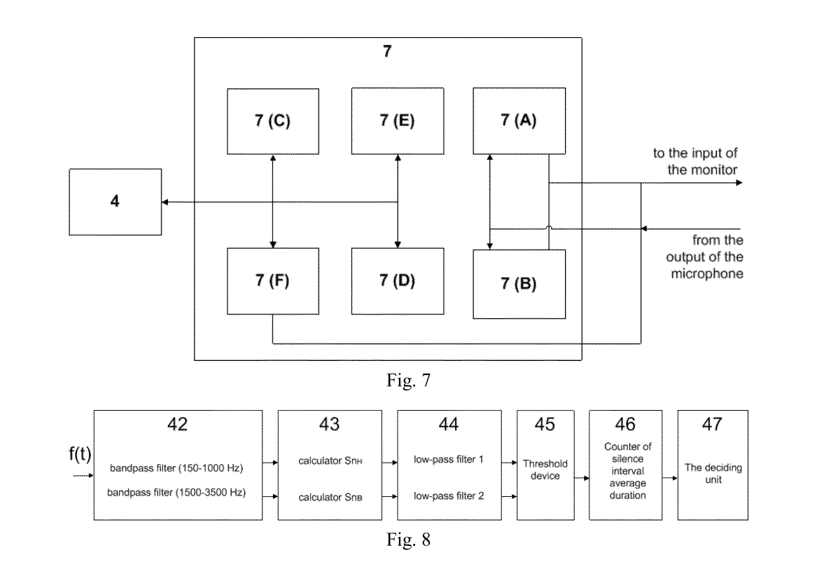

FIG. 7 shows the sub-units of the phrase recording unit as shown in FIG. 1;

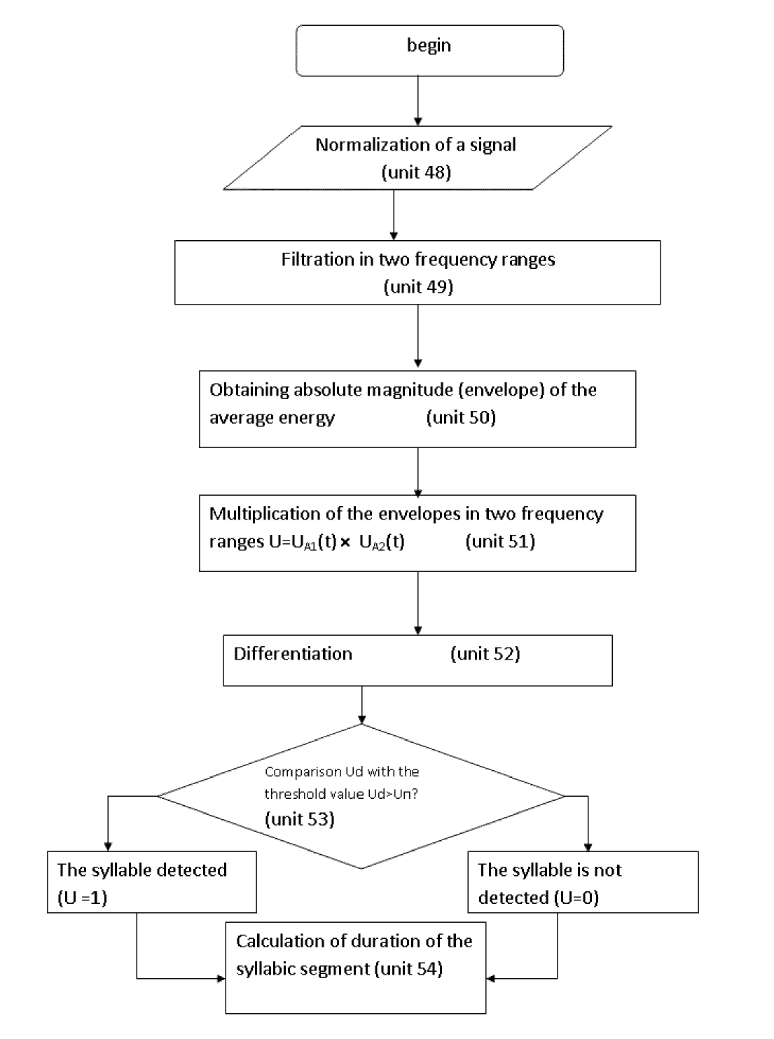

FIG. 8 shows the flowchart of the algorithm for extracting silent intervals and measuring their duration;

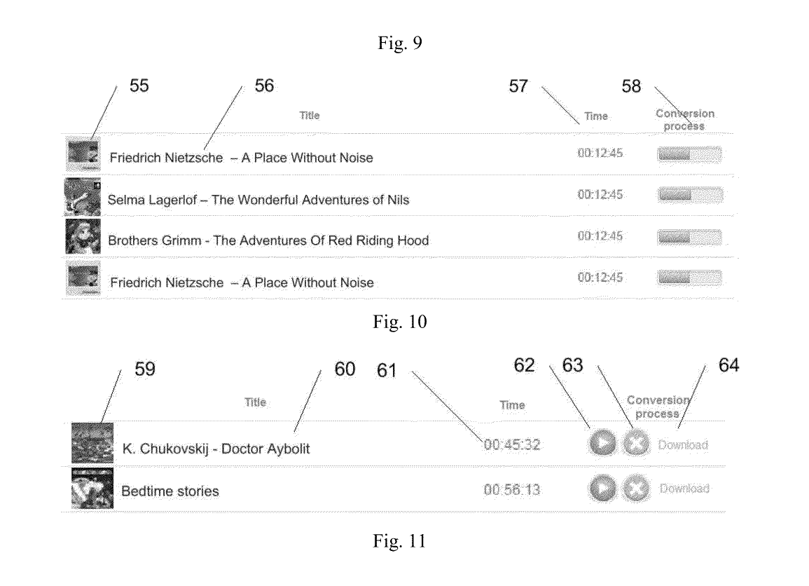

FIG. 9 shows the flowchart of the algorithm for evaluating duration of syllabic segments;

FIG. 10 shows the graphic interface of the audio material conversion form;

FIG. 11 shows the graphic interface of the conversion result form.

Since the method for re-sounding of materials is disclosed in detail in the description of the apparatus operation, the description of the apparatus will be given first.

The apparatus (FIG. 1) for re-sounding audio materials comprises the control unit 1, the audio material selection unit 2, the acoustic base 3 of initial audio materials, the acoustic base 4 of the target speaker, the teaching unit 5, the phrase playback unit 6, the phrase recording unit 7, the acoustic teaching base 8, the conversion unit 9, the conversion function base 10, the acoustic base 11 of converted audio materials, the conversion result display unit 12, the monitor 13, the keyboard 14, the pointing device 15 (mouse), the microphone 16, the sound playback device 17 formed by loudspeakers 18 and/or headphones 19. The keyboard output 14 is connected to the first input of the control unit 1, to the first input of the audio material selection unit 2, and to the first input of the conversion result display unit 12. The pointing device output 15 is connected to the second input of the control unit 1, to the second input of the audio material selection unit 2, and to the second input of the conversion result display unit 12. The monitor input 13 is connected to the output of the audio material selection unit 2, to the output of the teaching unit 5, to the first output of the phrase playback unit 6, to the output of the phrase recording unit 7, to the output of the conversion unit 9, to the output of the conversion result display unit 12. The input of the sound playback device 17 (loudspeakers 18 and/or headphones 19) is connected to the second output of the phrase playback unit 6. The microphone output 18 is connected to the input of the phrase recording unit 9. The first input/output of the control unit 1 is connected to the first input/output of the audio material selection unit 2, the second input/output of the control unit 1—to the first input/output of the acoustic base 4 of the target speaker, the third input/output of the control unit 1—to the first input/output of the teaching unit 5, the fourth input/output of the control unit 1—to the first input/output of the conversion unit 9, the fifth input/output of the control unit 1—to the first input/output of the conversion result display unit 12. The second input/output of the audio material selection unit 2 is connected to the first input/output of the acoustic base 3 of initial audio materials, and the second input/output of the acoustic base 3 of initial audio materials is connected to the fourth input/output of the conversion unit 9. The second input/output of the acoustic base 4 of the target speaker is connected to the first input/output of the phrase recording unit 7, and the second input/output of the phrase recording unit 7—to the third input/output of the teaching unit 5. The second input/output of the teaching unit 5 is connected to the first input/output of the phrase playback unit 6, and the second input/output of the phrase playback unit 6—to the input/output of the acoustic teaching base 8. The fourth input/output of the teaching unit 5 is connected to the first input/output of the conversion function base 10, the second input/output of the base 10 is connected to the second input/output of the conversion unit 9. The third input/output of the conversion unit 9 is connected to the second input/output of the acoustic base 11 of converted audio materials, and the first input/output of the acoustic base 11 of converted audio materials is connected to the second input/output of the conversion result display unit 12.

The apparatus may be provided with the authorization/registration unit 20 and the registered user base 21, the keyboard output 14 is connected to the first input of the authorization/registration unit 20, and the pointing device output 15 is connected to the second input of the authorization/registration unit 20, the monitor input 13 is connected to the output of the authorization/registration unit 20, the sixth input/output of the control unit 1 is connected to the first input/output of the authorization/registration unit 20, and the second input/output of the authorization/registration unit 20 is connected to the input/output of the registered user base 21.

The apparatus may be a remote server (as shown in FIG. 1 by dot-and-dash line S) provided with a specialized software (SSW)—units 1-12, then a user is able to log in to the site of the remote server S via, for example, the Internet from his computer device (as conditionally shown in FIG. 1 by dot-and-dash line C), using the monitor 13, the keyboard 14, the pointing device 15 (mouse), thus starting the functions of the said server, or the apparatus S may be installed directly to the user's personal computer via the Internet or with the use of a compact disc (CD) or DVD-disc (Digital Versatile Disc), then the apparatuses S and C form a single whole.

The apparatus (FIG. 1) works as follows.

By using the keyboard 14 and/or the pointing device 15 the user starts the control unit 1 that sends the command to start the apparatus functioning from its first input/output to the first input/output of the audio material selection unit 2. A request for obtaining a list of audio materials contained in the acoustic base 3 of initial audio materials is sent from the second input/output of the unit 2 to the first input/output of the acoustic base 3. Audio materials intended for re-sounding are stored in the acoustic base 3 as parametric audio files, for example, those having WAR. extension, that may be obtained and installed into the acoustic base 3 of initial audio materials with the use of the Internet, compact-discs, etc.

Audio materials are stored in the acoustic base 11 of converted audio materials, in the acoustic teaching base 8 and in the acoustic base 4 of the target speaker as WAV files (WAV from the English word “wave”).

A WAV audio file is transformed into a parametric audio file, for example, with WAR extension, or vice versa, by a parameterization module (not shown in FIG. 1) according to the known method.

A parametric file having the WAR extension describes an audio signal in the form of speech production parameters. The speech production model used in this technical solution consists of a main tone frequency (1st parameter), a vector of instantaneous amplitudes (2nd parameter), a vector of instantaneous phases (3rd parameter) and the remaining noise (4th parameter). These parameters characterize an acoustic signal (one such set corresponds to 5 ms) and are needed for performing the conversion procedure. During conversion these parameters are changed from parameters corresponding to an initial speaker to parameters corresponding to a target speaker (user), and an output signal in the WAV. format is formed (synthesized) therefrom.

A parametric file differs from a file in the WAV format in that the WAV file described a signal as a sequence of time counts, while a parametric audio file described a signal as a parameter set for a speech production model, parameters of which are changed during the conversion process. The main advantage of a parametric file is that a signal in the form of a sequence of time counts may not be directly processed in the way required by the conversion (e.g., its timbre may not be evaluated or changed). Disadvantages of a parametric file, as compared to a file in the WAV format, are that it requires more disc space and does not ensure full restoration of an initial signal, if speech is not to be modified.

So, it is principally important from the point of processing speed and conversion that the acoustic base 3 of initial audio materials stores files in the form of parametric files having WAR extension (or equivalent), and the acoustic base 4 of the target speaker, the acoustic teaching base 8, the acoustic base 11 of converted audio materials store files in the form of WAV files (or equivalent).

After processing a request from the first input/output of the acoustic base 3 data on the list of audio materials is transmitted to the second input/output of the audio material selection unit 2, which arrives to the user's monitor 13 from the output of the unit 2 and is displayed on its screen in the graphic interface (FIG. 2).

The graphic interface comprising a list of audio materials may have various appearances, shapes and tools (FIG. 2 shows one possible embodiment).

For example, the audio material selection form has a line 22 of filtering audio materials with the following tools:

“All”—Button 23, pressing of which with the pointing device 15 results in displaying the full list of audio materials from the acoustic base 3 of initial audio materials in the audio material selection form;

“New”—Button 24, pressing of which results in displaying information on N (pre-set in the apparatus configuration parameters) audio materials installed last (in time) into the acoustic base 3 of initial audio materials in the audio material selection form;

“Popular”—Button 25, pressing of which results in displaying information on N audio materials most frequently re-sounded by users in the audio material selection form;

“Age”—the drop-down list 26 for selecting an age range. After selecting an age value in the drop-down “Age” list 26, the graphic interface of audio material selection shows a list of audio materials intended (by interest) for the age selected;

“Search”—the field 27 for entering a line for searching audio materials. A search is conducted by the title of an audio material (text line associated with each audio material having its respective title. The audio material title is stored in the acoustic base 3 of initial audio materials). After entering a search line (search criterion) into the field “Search” the audio material selection form shows a list of audio materials matching the search criterion. For example, if the word “Doctor” is entered into the field “Search”, the graphic interface of audio material selection shows audio materials titles of which comprise the word “Doctor” (“Doctor Aibolit”, “Doctor Zhivago”, etc.).

The field 28 comprises a list of audio materials filtered according to the criteria indicated in the filtration line 22. Each entry in the list shows information associated with a particular audio material and stored in the acoustic base 3 of initial audio materials. This information includes:

the title 29 of an audio material;

a graphic representation 30;

a brief description 31 of the audio material content.

The graphic interface form also comprises:

Button 32 “Select”, after pressing of which the audio material selection unit 2 places the respective audio material into a list of audio materials for re-sounding—“Basket” (the term “Basket” means a list of audio files selected by a user for re-sounding from the acoustic base 3). The Basket is stored in the random access memory (RAM) of the unit 2. When necessary, the unit 1 operatively extracts the Basket from the unit 2. In essence, the control unit 1 is the functional manager of the apparatus processes, analogously to the Process Manager in Windows, and the unit 1 keeps the functioning of the other units 2-12 synchronized in accordance with the process operations performed thereby, and their functional sequence.

Button 33 “Re-sound”, after pressing of which the process of re-sounding audio materials added to the list of audio materials to be re-sounded (to the “Basket”) is started. If the Basket is empty, the “Re-sound” button is inaccessible.

The user, using the keyboard 14 and/or the pointing device 15, adds audio materials of interest to him to the Basket by pressing the “Select” button 32 in the list displayed on the screen of the monitor 13.

The audio material selection unit 2 forms a list of audio materials selected by the user as follows.

After the tool, i.e., the “Select” button 32 is pressed, the apparatus operating system initiates the event of button pressing—a material is selected for re-sounding. Data on this event (instruction) is transmitted to the audio material selection unit 2 that moves the selected audio materials into the Basket, i.e., into a list comprising data on audio materials selected by the user and being stored in RAM of the unit 2).

In the same way as described above, the user, using the keyboard 14 and/or the pointing device 15, issues the instruction to start the re-sounding process in respect of the audio materials from the Basket by pressing the “Re-sound” button 33.

The instruction to stop forming the Basket, i.e., to confirm that the user has selected at least one audio material for re-sounding, is transmitted from the first input/output of the audio material selection unit 2 to the first input/output of the control unit 1.

Several embodiments of the apparatus for re-sounding of audio materials are possible:
as SSW installed on the computer and functioning in the single-user mode. In this case no authorization/registration is required, and the authorization/registration unit 20 and the registered user base 21 are not needed;
as SSW installed on the computer and functioning in the multi-user mode (for example, a family where mother, father, children use this program). In this case authorization/registration is required;
if the apparatus is implemented on the basis of a remote server as a web-application, authorization/registration is required.

For example, if a remote server S is used, then after at least one material is added to the Basket, the control unit 1 activates in the succession—the sixth input/output of the unit 1—the first input/output of the authorization/registration unit 4—the function of the user authorization through the unit 20. The unit 20 initiates the authorization/registration form of the graphic interface, which is transmitted from its output to the monitor input 13 for displaying it to the user.

The authorization/registration form (FIG. 3) has the following fields: 34—“Email” intended for entering the user's e-mail address; 35—“Password” intended for entering the user's password. The authorization/registration form also comprises the following tools (buttons): 36—“Log-in”, after the button 36 is pressed, the authorization/registration unit 20 uses its second input/output for checking whether information on the user with entered account data (e-mail and password) is available in the registered user base 21;

37—“Registration”, after the button 37 is pressed, the authorization/registration unit 20 initiates the process for registering the user in the registered user base 21.

The user, using the pointing device 15 and the keyboard 14, fills in the displayed form (FIG. 3), i.e., enters his account data (email and password) and issues the instruction for authorization to the authorization/registration unit 20. The unit 20 uses its second input/output for transmitting an information request whether the registered user with the entered account data is in the base 21 to the input/output of the base 21.

If no user with the entered account data is present in the base 21, a message about authorization error comes from the output of the unit 20 to the monitor screen 13, for example, “The user with the entered account data is not registered. Enter the correct account data or register in order to continue working”. The user, using the keyboard 14 and the pointing device 15, enters his email (login) into the field 34 of the authorization/registration form and presses the button 37 “Registration”. The authorization/registration unit 20 generates a password and a user's unique identifier (ID) for the user. The unit 20 displays the generated password (it is necessary for the user for next authorizations in the apparatus) on the monitor screen 13. The user's data (email entered by the user, and generated password and ID) is transmitted from the second input/output of the unit 20 to the input/output of the registered user base 21 in order to be stored in the base 21.

If the user with the entered account data has already been registered in the base 21, then the registered user base 21 transmits the user's unique ID from its input/output to the second input/output of the unit 20. The authorization/registration unit 20 stores the user's ID. When necessary, the unit 1 operatively extracts ID from the unit 20.

A list of audio files (“Basket”) and the user's ID are the values stored in global variables (in the case of a remote server it is the CloneBook web-application). During the whole session of the user's work with the apparatus these global variables are accessible for all the other units of the computer device.

Then the control unit 1 sends a request from its second input/output to the first input/output of the acoustic base 4 of the target speaker, in order to check whether there are phrase records of the user with this ID (to know whether the user has taught the claimed apparatus with a specimen of his voice before). The unit 1 operatively extracts the user's ID from the memory of the unit 20 as follows: from the sixth input/output of the unit 1 to the first input/output of the unit 20. The user's phrase records are stored in the acoustic base 21 in the form of audio files in the directory which name comprises the user's ID only (the user's directory stores records of his phrases).

If ID of this user is not found in the acoustic base 21 (the user has not taught the apparatus to recognize the specimen of his voice), then the instruction to start functioning comes from the third input/output of the control unit 1 to the first input/output of the teaching unit 5, and, in accordance with this instruction, the respective instructions successively come from the second input/output of the unit 5 and from its third input/output to the first input/output of the phrase playback unit 6 (from the teaching base) and to the second input/output of the phrase recording unit 7 (into the base) of the user. Thus, the unit 1 controls the unit 5 (by giving the instruction to start functioning to it), and the unit 5, in its turn, controls the units 6 and 7.

The phrase playback unit 6 is designed to playback a phrase from the teaching base 8 to the user, therefore its second input/output is connected to the input/output of the acoustic teaching base 8, and its output to the sound playback device 17 (loudspeakers 18 and/or headphones 19). WAV-files from the teaching base 8 are converted into audio phrases by the driver. After hearing a phrase, the user should repeat it into the microphone 16 when the apparatus issues the signal of the “ready to record” type. The unit 9 is designed for recording a phrase repeated by the user, and its input is connected to the output of the microphone 16. Analog signals of the microphone 16 and the sound playback device 17 are converted into digital signals by drivers of the respective devices. For example, a sound from the microphone 16 is converted into a digital RAW-stream (audio stream) by a driver of the sound card.

Time ΔT is set by the unit 7 for recording a user's phrase, and the user should repeat a phrase played back by the unit 6 within this time (time ΔT is determined according to duration of a phrase recorded in the acoustic teaching base 8).

Before phrases are repeated by the user and recorded into the acoustic base 4, the graphic interface of a background noise record is transmitted from the output of the unit 7 to the monitor screen 13.

The graphic interface of a background noise record (“Error! Reference source is not found.”) comprises:

The button 38 “Start recording” that is pressed to start the process of recording background noise. Background noise is read by the microphone 16 and transmitted to the input of the phrase recording unit 7, then, as an audio stream, it is transmitted from the first input/output of the unit 7 to the second input/output of the acoustic base 4 of the target speaker, and this audio stream is stored in the form of an audio file. This audio file with background noise is stored in the acoustic base 4 in the user's directory (the name of which contains the user's ID).

The audio file with background noise is stored in the acoustic base 4 in the directory the name of which contains the user's ID only. This directory is generated by the acoustic base 4 before storing the first phrase recorded by the user. The acoustic base 4 prompts the control unit 1 for the user's ID along the line “the first input/output of the base 4”—“the second input/output of the unit 1”. The control unit 1 operatively extracts the user's ID from the unit 4 along the line “the sixth input/output of the unit 1”—“the first input/output of the unit 20”.

The indicator 39 of the background noise recording is formed on the monitor screen 13 (FIG. 4).

The user presses the button 38, using the pointing device 15. The user should keep silence when background noise is recorded (the cursor of the indicator 39 moves from 0 to 100%).

When the background noise recording is completed, the phrase playback unit 6 transmits the graphic interface of phrase playback to the monitor screen 13 for displaying (“Error! Reference source is not found.”). The phrase playback unit 6 receives a particular phrase from the acoustic teaching base 8 in the form of a file and plays it back to the user with the sound playback device 17.

The acoustic teaching base 8 comprises a certain number of audio files with phrases (practically realized) the number of which is, for example, thirty six. The unit 6 plays them back in succession, a specific succession of their playback being not of importance. The unit 8 stores the information which phrases have been already played back by the unit 8 and which are to be played back.

Teaching phrases for a particular audio material are selected as follows. The acoustic base 3 of initial audio materials compares each audio material to a list of phrases from the acoustic teaching base 8. This comparison is carried out as a list of the following type: “audio material-01.wav”—“phrases from 10: 001.wav, 005.wav, 007.wav . . . ”. Phrases for an audio material from the acoustic base 3 are selected by a text allophonic analysis, for example, by an automated method (National Academy of Sciences of Belorussia, Combined Institute for Informatics Problems. Lobanov B. M., Tsirulnik L. I. “Computer Synthesis and Speech Cloning”, Minsk, Belorusskaya Nauka, 2008, p. 198-243) and stored in the acoustic teaching base 8.

The graphic interface of phrase playback (“Error! Reference source is not found.”) shows the played-back phrase indicator 40 comprising:
the text of a played back phrase (for example, shown in FIG. 5 this is the text—“Cold winter is coming”). This text is correlated with a particular phrase and stored together with it in the acoustic teaching base 8 as a text file. The phrase playback unit 6 loads this text together with an audio file to be played back and shows it in the graphic interface of the played-back phrase indicator 40;
a cursor moving along the phrase text during its playing back. During playback of a phrase the cursor location is synchronized with phrase playback. That is, the cursor is at the first symbol of the phrase text in the beginning of phrase playback, and at the last symbol in the end of playback. The cursor movement speed takes into account the rate of reading a phrase from the acoustic teaching base 8 by the speaker. That is, if a speaker of an audio phrase “drawls” a letter in a word, the cursor “lowers” a movement speed at this letter (for example, if the word “Scissors” is pronounced by a speaker with a delay at the letter “i”, i.e., “Sci-i-i-i-issors”, then the cursor also lowers its movement speed).

Information on the cursor location (its movement speed along text) is contained in the parametric file of cursor speed. A parametric file of cursor speed represents a set of value-match pairs “cursor location—m/s”. Each phrase (audio file) from the acoustic teaching base 8 has its respective parametric file of cursor speed, for example, with the CAR extension.

The teaching unit 5 forms the instruction for starting the phrase playback unit 6 along the line “the second input/output of the unit 5—the first input/output of the unit 6”; the instruction is to play back the next phrase from the acoustic teaching base 8. Sequence is determined by the unit 6. After the unit 6 plays back a phrase and returns the operation result to the unit 5 (the result is the number of the played back phrase, for example, “001.wav”), the unit 5 generates the instruction for starting the phrase recording unit 7 (along the line “the third input/output of the unit 5—the second input/output of the unit 7”). The unit 7 records a user's phrase and returns the result to the unit 5 (along the same line. The result is the number of the phrase recorded in the base 4, for example, “002.wav”). This cycle is repeated for each phrase from the teaching acoustic base 8.

After the user listens to the phrase, he causes this phrase to be recorded. The user should speak the listened phrase at the same speed. The phrase recording unit 7 displays the next possible graphic interface of phrase recording on the monitor screen for the user (“Error! Reference source is not found.”).

The graphic interface of phrase recording has the recorded phrase indicator 41 comprising:
text of the played back phrase (in “Error! Reference source is not found.” it is the text “Cold winter is coming”);
the cursor moving along the phrase text according to how the user should repeat it. The speed of playing back the phrase in accordance with the text is in a parametric file of cursor speed (described above).

The user speaks the listened phrase into the microphone 16. An audio stream from the output of the microphone 16 goes to the phrase recording unit 7 that, via its first input/output, comes to the second input/output of the acoustic base 4 of the target speaker and is stored in the base 4 in the form of an audio file. This audio file is stored in the acoustic base 4 in the directory the name of which contains the user's ID only. This directory is generated (before storing the first phrase recorded by the user) by the acoustic base 4. The acoustic base 4 prompts the control unit 1 for the user's ID along the line “the first input/output of the acoustic base 4”—“the second input/output of the unit 1”. The control unit 1 operatively extracts the user's ID from the unit 20 along the line “the sixth input/output of the unit 1”—“the first input/output of the unit 20”.

During recording of a phrase, the phrase recording unit 7 monitors the user's speech rate (FIG. 7). If the user teaching a computer device speaks too fast or too slowly (violates the speech rate), the unit 7 (A) for monitoring speech rate (out of the composition of the phrase recording unit 9) displays a warning on speech rate violation on the monitor screen 13, for example, “You speak too fast, speak more slowly” (if the user speaks too fast) or “You speak too slowly, speak faster” (if the user speaks too slowly). Warning texts are contained in the program of the unit 7 (A).

The unit 7 (A) for monitoring speech rate (a proprietary development) determines speech rate as follows.

The determination of speech rate is based on two algorithms: determination of silence interval duration and extraction as well as evaluation of syllabic segment durations in a speech signal. Silence intervals are localized by a method of digital filtration in two spectral ranges corresponding to localization of energy maximum values for voiced and noisy (non-voiced) sounds with the use of Lerner's filters of fourth order, “weighing” of instantaneous energy of a speech signal in two frequency ranges with the use of rectangular window having the duration of 20 ms.

The determination of syllabic segment duration is based on the corrected hearing model taking into account spectral distribution of vowel sounds and filtration in two mutually correlated spectral ranges. A decision on the fact that a speech segment belongs to a syllable comprising a vowel sound is taken, and the vowel sound is localized by a software combinational logic circuit.

The final decision on the speech rate of a speaker is taken on the basis of an analysis with the two algorithms during an information accumulation interval: for the whole file in the off-line mode or by reading a stream (file) with outputting results every 15 s.

In the general case, the speech rate determination algorithm comprises the following steps:
Normalization of a speech signal. It ensures equalization of weak (low) signals for the purpose of excluding dependence of results on loudness of an input speech signal.
Extraction and measurement of silence interval durations. Forming of primary rate features. (Algorithm 1)
Evaluation of syllabic segment durations. Forming of main features (Algorithm 2)
   Taking decision on rate of a repeated phrase.

1.Normalization of an Input Speech Signal of a Repeated Phrase

An input signal is normalized for the purpose of excluding dependence of measurements on an amplitude (loudness) of a recorded or inputted signal.

Normalization is carried out as follows:
a search for a maximum absolute amplitude value is conducted on intervals having the duration of 1 s;
an average value is taken in the array obtained;
a conversion factor is determined according to the formula as a relation between an amplitude maximum possible value and the obtained average value;
each input signal value is multiplied by the conversion factor.

2. Extraction and Measurement of Silence Interval Durations (Algorithm 1)

This method is based on measurement of instantaneous energy in two frequency ranges corresponding to maximum energy concentration of voiced (frequency range from 150 to 1,000 Hz) and non-voiced (frequency range from 1,500 to 3,500 Hz) sounds.

The flowchart of Algorithm 1 is shown in “Error! Reference source is not found.”.

2.1. Filtration

The unit 42 conducts second-order filtration (with a Lerner's filter) of an input speech signal (a user's phrase played back) into an output speech signal.

An input speech signal is a digital RAW-stream (from the English word “raw”)—audio stream—signal value from 0 to 32768 is a dimensionless quantity.

The formula of a typical section of second-order filtration (of Lerner's filter) is equivalent to the difference equation in the time domain of the following type:

$$Y ( n ) = ( 2 \times Y 1 - X 1 ) \times K 1 - Y 2 \times K 2 + X ( n ) ; where$$

$$K 1 = K \times cos ( 2 π \frac{Frq}{Fd} ) ;$$

$$K = 1.0 - \frac{π \times Pol}{Fd} ;$$

$$K 2 = K \times K ;$$

X(n)—current value of an input signal;

Y(n)—current value of an output signal;

Y1—output signal value delayed by one sampling period;

Y2—output signal value delayed by two sampling periods;

Pol—bandwidth in Hz;

Pol=850 Hz for the first and 2,000 Hz for the second band-pass filters;

Fd—sampling frequency in Hz. Fd=8,000 Hz;

Frq—average frequency of filter band in Hz, Frq=575 Hz for the first and 2,500 Hz for the second band-pass filters;

K, K1, K2—filtration coefficients.

A fourth-order filter is implemented by cascade successive connection of two second-order sections of the above type.

2.2. Calculation of Speech Signal Instantaneous Energy

Calculation of speech signal instantaneous energy is carried out by the unit 43.

Calculation of instantaneous energy is carried out on intervals (in window having duration of 20 ms), which corresponds to 160 counts of an input speech signal for the sampling frequency Fd=8,000 Hz.

The succession of actions when calculating instantaneous energy is as follows:
module Yns =Abs (Y(n))—straightening of a filter output signal—is calculated;
then a value of energy instantaneous quantity in the window of 20 ms (160 counts) is calculated according to the formula

$$Sn = M \times {\sum }_{1}^{160} {Y}_{nB} \times {Y}_{nB} ,$$

where

Sn—value of instantaneous energy in the n-th window (SnB—for the range from 1,500 to 3,500 Hz and SnH—for the range from 150 to 1,000 Hz);

Yn—filter output value;

YnB—straightened output value;

M—scale factor limiting overflow. It is determined experimentally that the quantity M for performing conversions may be taken as 160.

Instantaneous energy is calculated in two frequency ranges corresponding to band-pass filters (see 2.1).

2.3. Calculation of Low-Pass Filter

Calculation results for instantaneous energy are smoothed (averaged) by the unit 44, for which a first-order low-pass filter is used that corresponds to the difference equation Y(n)=(1−k)Y1−1+Sn,

Y(n)—current output value of low-pass filter;

Sn—current input value of low-pass filter (instantaneous energy value);

Y1—output signal value delayed by a sampling period;

κcoefficient determining a time constant or cut-off frequency of a low-pass filter.

2.4. Threshold Device

The threshold device (unit 44) compares a current value of average energy smoothed value in a given band to a threshold value (to be determined experimentally), and the value of 50 mV may be taken as the initial level. An energy value that is less than threshold levels in the two spectral ranges may be taken as a silence interval. Count of silence interval duration is started from that time.

2.5. Counter of Silence Interval Average Duration in a File

An average duration of a silence interval in a processed file or on a segment under analysis (unit 45) is determined as a sum of durations of all silence intervals, as divided by their number.

$$Tcc = 1 / N ( {\sum }_{1}^{Ni} Ti )$$

where:

Tcc—average duration of a silence interval in a processed file or on a segment under analysis;

Ti—i-th silence interval in a processed file or on a segment under analysis;

N, Ni—number of silence intervals in a processed file or on a segment under analysis;

2.6. The Deciding Unit

The unit 47 decides on compliance of a speech rate. A decision on speech rate is taken, proceeding from the following provisions:
If an average duration Tcc of a standard silence interval or the value of 600 ms is exceeded, the rate is considered as slow. The standard is a file in the WAV format with record parameters of 16 bit 8,000 Hz, which is obtained experimentally. It is stored in the unit 7 (A) for monitoring speech rate.
If Tcc has a value less than an average duration of standard silence interval or the value of 300 ms, the rate is considered as fast.
In the opposite case it is considered as complying with the standard.

3. Evaluation of Syllabic Segments Durations (Algorithm 2)

The method for separating syllabic segment features in a played back phrase is based on forming primary parameters using signal envelopes in the frequency ranges A1=800-2,500 Hz and A2=250-540 Hz. The resulting parameter that is then used for separating syllable features may be obtained by the correlation method and is determined as follows:

U_{c}(t)=U_{A1}(t)U_{A2}(t). (2)

where U_{A1}(t)—energy envelope in the frequency band A1, and U_{A2}(t)—energy envelope in the band A2.

The frequency range of the first band-pass filter, which is equal to 250-540 Hz, is selected due to the fact that it lacks energy of high energy fricative sounds, such as /sh/ and /ch/, that create erroneous syllabic cores, and also concentrates a significant part of energy of all voiced sounds, including vowels. However, energy of the resonant sounds, such as /l/, /m/, /n/, is comparable to energy of vowels, due to which determination of syllabic segments only with taking into account of the speech signal envelope in this range is accompanied by errors. Therefore, the frequency range for the second band-pass filter is selected within the limits of 800-2,500 Hz, wherein the vowel energies exceed the resonant sound energies at least two times.

Owing to the operation of multiplying the envelopes U_{A1}(t) and U_{A2}(t) in the resulting time function parts of curves are strengthened in the field of vowels due to correlation of their energies in the two ranges. Furthermore, erroneous energy maxima, as pre-determined by the presence of a significant part of the fricative sound energies in the range from 800 to 2,500 Hz, are eliminated by multiplying them by a practically zero value of the fricative sound amplitudes in the range from 250 to 540 Hz.

When using the Algorithm 2, the succession of the operations is as follows (FIG. 9):
A repeated phrase (signal) is normalized by the unit 48. Normalization of a speech signal ensures equalization of weak (low) signals for the purpose of excluding the dependence of measurements on loudness of an input speech signal.

Normalization of a repeated phrase (input speech signal) is carried out for the purpose of excluding the dependence of measurements on an amplitude (loudness) of a recorded or inputted signal.

Normalization is carried out as follows:
a search for a maximum absolute amplitude value is conducted on intervals having duration of 1 s;
an average value is determined from an array obtained;
a conversion factor is determined according to the formula as a relation between an amplitude maximum possible value and the obtained average value;
each input signal value is multiplied by the conversion factor.
Filtration of a repeated phrase (signal) by two fourth-order band-pass Lerner's filters in the ranges from 250 to 540 Hz and from 800 to 2,500 Hz, respectively (unit 49);
Detection of the filter output signals for obtaining envelopes (unit 50);
Multiplication of the envelopes of the filter output signals (unit 51);
Differentiation of a resulting signal (unit 52);
Comparison of the resulting signal to the threshold voltages and separation of a logic signal corresponding to the presence of a syllabic segment (unit 53).
Calculation of duration of the syllabic segment (unit 54).

4. Mechanism for Deciding on Speech Rate

A decision on a speech rate is based on a result of calculations of silence interval syllabic segment durations. For this, the following combinatory logic is realized:
silence intervals are long, and syllables are long—a rate is slow. The criterion of “long” is a deviation of duration from standard ones by 30%. A standard file in the WAV format with the record parameters of 16 bit 8,000 Hz is obtained experimentally. It is stored in the unit 7 (A) for monitoring speech rate;
silence intervals are short or absent, and syllables are short—a rate is fast. The criterion of “short” is a deviation of duration from standard ones by 30%;
silence intervals are long, and syllables are short—a rate is fast, i.e., a syllable analysis has the priority, a warning on long silence intervals being displayed;
silence intervals are short or absent, and syllables are long—a rate is slow.

The phrase recording unit 7 (FIG. 7) monitors loudness of the user's speech. If the user speaks too loudly or too quietly, the unit 7 (B) for monitoring speech loudness (out of the composition of the phrase recording unit 7) displays a warning on violation of loudness of a repeated phrase on the monitor screen 13, for example: “You speak too loudly, speak quietly” (if the user speaks too loudly) or “You speak too quietly, speak more loudly” (if the user speaks too quietly). The warning texts are in the text of the program of the phrase recording unit 7. The unit 7 (B) for monitoring speech loudness monitors loudness of a speaker as follows: it conducts a check whether a current signal level is within the allowable range of signal levels. The signal level range is pre-set in the text of the program of the unit 7 (B) as constant values. When using WAV-FILES, a signal loudness level does not have units of measurement. Its value changes from 0 (no sound) to 32768 (MAX volume).

For example, let it be preset:
“range lower limit” is equal to 8,000;
“range upper limit” is equal to 28,000;
If a current signal level value exceeds the range upper limit, the warning “Too loudly” is displayed on the monitor screen 13. If a current signal level value is below the range lower limit, the warning “Too quiet” is formed.

After recording a phrase corresponding to and satisfying the pre-set parameters for the units 7 (A) and 7 (B), the phrase recording unit 7 processes the stored audio file (with the user's phrase) in the following succession:
normalization is carried out by the normalization unit 7 (B) (out of the composition of the phrase recording unit 9) as follows: the signal level greatest value Lf is isolated in a recorded phrase. Then, the factor k is calculated that is equal to the ratio of the maximum signal level (Lmax=32,000) and the signal level greatest value in the recorded phrase: k=Lmax/Lf. Then, the signal levels in the recorded phrase are increased by the value of the factor k. Normalization is carried out for the purpose of bringing the signal loudness to the maximum;
cutting-off consists in removing silence intervals (record parts where speech is absent for more than 500 ms) from the recorded phrase. Cutting-off is carried out by the unit 7 (E) for cutting-off (out of the composition of the phrase recording unit 7), audio files are supplied to the input of the unit 7 (E) as WAV-files;
noise reduction is realized as the standard algorithm for removing noise from a useful signal on the basis of the spectral subtraction. Noise reduction is carried out by the unit 7 (D) for noise reduction (out of the composition of the phrase recording unit 7);
monitoring of compliance between the pronounced and pre-set texts of a phrase. That is, the user's speech is converted into text (STT—speech-to-text technology), and the obtained text is compared to the text the user should repeat. The algorithm for converting speech to text is realized in the unit 7 (F) for monitoring compliance (out of the composition of the phrase recording unit 7. A recorded phrase (the one that has been repeated by the user) is converted into text. The obtained text is compared to the text that should be read (it is contained in the acoustic teaching base 8). If there is incompliance between the repeated and the pre-set texts, the unit 7 (F) for monitoring compliance displays a message on necessity of re-record the respective phrase on the monitor screen 13 for the user. In this case the phrase recording unit 7 starts the process of re-recording this phrase, i.e., the phrase is played back for the user (FIG. 5), and the user's phrase is recorded (FIG. 6).

In respect of all the phrases, as contained in the acoustic teaching base 8, the teaching unit 5 by analogy and in succession:
plays back the phrases to the user (FIG. 5);
records the user's phrases (FIG. 6).

The result is a set of audio files with the user's phrases recorded in the acoustic base 4 of the target speaker.

Then, the teaching unit 5 forms a conversion function file from the recorded phrases, the file having no extension (the conversion function is required for converting the voice of an initial speaker into the voice of the respective user). While doing so, the teaching unit 5 evaluates a quantity of “approximate” time necessary for obtaining the conversion function with due regard to conversion of audio materials. The teaching unit 5 displays obtained time on the monitor screen 13 for the user as the text: “Wait. 01:20:45 remains”. The displayed time is renewed on the monitor screen 13 with a period determined by the settings of the teaching unit 5. “Approximate” time is calculated by the unit 5 for teaching on the basis of statistics accumulated in its inner memory. These statistics include the following data on already fulfilled tasks of obtaining the conversion function and conversion itself: a volume of recorded audio files containing the user's phrases, a real time necessary for obtaining the conversion function and conversion itself, a number of conversion tasks executed in parallel with this task (several users may use the apparatus simultaneously; therefore, a situation is possible where conversions of different users overlay each other, i.e., conversion tasks may be executed in parallel to each other).

When calculating an approximate conversion time, the teaching unit 5 determines the closest value from the statistics according to the following criteria: a volume of audio materials, a number of executed conversion tasks. The teaching unit 5 stores a created conversion function file in the conversion function base 10 under the respective user's ID.

Then, the teaching unit 7 evaluates the conversion function by way of progressive approximations. The input parameters are amplitude spectral envelopes of speech signals of the initial speaker and the target speaker (the user). In order to calculate an error in conversion, the succession of amplitude spectral envelopes of the initial speaker (as stored in WAV-files) is converted with the use of the current conversion function, and a distance between the obtained conversion and the target one is calculated. Any error is normalized, i.e., divided by a number of envelopes in the succession.

A conversion error in this terminology is the Euclidian norm of amplitude spectral envelopes for speech signals of the initial speaker and the target speaker, in other words, a mean-square value of a timbre component conversion error, wherein the said component is determined by a spectrum envelope. It may be obtained only after the conversion function is determined, and the very conversion procedure is performed.

That is, the unit 7 also calculates a value of “mean-square value of a timbre component conversion error”. The resulting value is compared to thresholds:
from d₁₁ to d₁₂: good conversion;
from d₂₁ to d₂₂: satisfactory conversion;
from d₃₁ to d₃₂: bad conversion—phrases should be re-recorded.

d₁₁, d₁₂; d₂₁, d₂₂; d₃₁, d₃₂ are the lower and the upper values of “mean-square conversion error” for “good”, “satisfactory” and “bad” conversion, respectively (to be selected experimentally).

If phrases are to be re-recorded, the teaching unit 5 displays a message on the necessity to re-record phrases on the monitor screen 13. The teaching unit 5 re-records phrases: the instructions come in succession from the second input/output of the unit 5 and from its third input/output, respectively, to the first input/output of the phrase playback unit 6 from the acoustic teaching base 8 and to the second input/output of the phrase recording unit 7 in the acoustic base 4 of the target speaker (user).

Audio materials are converted by the conversion unit 9 that requests and receives, along the line “the first input/output of the conversion unit 9—the fifth input/output of the control unit 1”, from the control unit 1 these audio materials being in the “basket”. The unit 1 operatively extracts these audio materials from the memory of the audio material selection unit 2 along the line “the first input/output of the unit 1”—“the first input/output of the unit 2” and converts the audio materials from the “basket”, using the conversion function file received from the conversion function base 10. The unit 9 converts the parametric file of the unit 2 and converts it into a WAV-file for storing in the acoustic base 11 of converted audio materials.

The conversion unit 9 displays the graphic interface of audio material conversion through the output, which is connected to the input of the monitor 13, on its screen (“Error! Reference source is not found.”).

The graphic interface of audio material conversion (“Error! Reference source is not found.”) has:
the graphic representation 55 associated with an audio material to be converted (see above);
the title 56 of an audio material to be converted;
the field 56 of approximate time of the audio material conversion, as calculated by the conversion unit 9 on the basis of statistics accumulated in its inner memory;
the indicator 58 of the conversion process (0%—beginning of conversion; 100%—conversion completed).

The conversion unit 9 transmits audio materials repeated by the user's voice from its third input/output to the second input/output of the acoustic base 9 of converted audio materials for storing them in the form of audio files.

The line “the sixth input/output of the control unit 1”—“the first input/output of the acoustic base 11” is for:
requesting and receiving by the unit 1 of information on a converted material from of the unit 11 for the purpose of displaying such information on the monitor screen 13 in the graphic interface of conversion results for audio materials;
controlling the acoustic base 11 (the control is carried out by the user's instruction through the control unit 1);
removing an audio file of a converted audio material from the acoustic base 11 of converted audio materials;
playing back a converted audio material to the user through the sound playback device 17;
re-recording the audio file of a converted material from the acoustic base 11 of converted audio materials to a user's portable data medium.

The re-sounding process is completed. The user may listen to re-sounded audio materials on the sound playback device 17 (loudspeakers 18 and/or headphones 19) as well as write audio files containing re-sounded audio materials to a portable data medium.

When re-sounding is completed, the control unit 1 issues the instruction to start the conversion result display unit 12 from its fifth input/output to the first input/output of the unit 12. The instruction parameter is the ID of the user whose audio materials have been re-converted by the apparatus. A request for obtaining a list of the converted audio materials of the user having the pre-set ID is transmitted from the second input/output of the unit 12 to the first input/output of the acoustic base 11 of converted audio materials. The converted audio materials are stored in the acoustic base 11 in the form of audio files in the directory the name of which contains the user's ID only. After processing the request, data on a list of the converted audio materials is transmitted from the first input/output of the acoustic base 11 to the second input/output of the unit 12, and from the output of the unit 12—to the user's monitor 13 and is displayed on the screen in the graphic interface of audio material conversion results (“Error! Reference source is not found.”).

The graphic interface containing a list of converted audio materials may have various appearances, forms and tools (one of its possible embodiments is shown in “Error! Reference source is not found.”).

For example, the graphic interface of audio material conversion results has:
the graphic representation 59 associated with a converted audio material;
the title 60 of an audio material to be converted;
the field 61 of record duration in the format hh.mm.ss.;
the button 62 for playing back a converted audio material through the sound playback device 17;
the button 63 for removing the audio file of a converted audio material from the acoustic base 11 of converted audio materials;
the button 64 for writing the audio file of a converted audio material from the acoustic base 11 of converted audio materials to a user's portable data medium.

After pressing the tool—button 62 “Playback” the operating system of the apparatus generates the event—to playback a selected converted audio material through the device 17. The information on this event (instruction) is transmitted to the unit 12 for displaying converted audio materials that prompts the acoustic base 13 for a particular converted audio material (along the line “the second input/output of the unit 14—the first input/output of the acoustic base 13”) in the form of a file and plays it back for the user through the sound playback device 17.

Thus, the apparatus realizes the following method of re-sounding audio materials:
the acoustic base of initial audio materials comprising parametric files and the acoustic teaching base comprising WAV-files of the speaker's teaching phrases and the corresponding acoustic base of initial audio materials are formed in the program-controlled electronic information processing device;
the data from the acoustic base of initial audio materials are transmitted for displaying a list of initial audio materials on the monitor screen;
if the user has selected at least one audio material from the list of the acoustic base of initial audio materials, the data on this material is transmitted for storing in the random-access memory of the program-controlled electronic information processing device;
the WAV-files of the speaker's teaching phrases, which correspond to the selected audio material, are selected in the acoustic teaching base, converted into audio phrases and transmitted to the user's sound playback device;
the user repeats the audio phrases into the microphone, and in the process of repeating the text of a repeated phrase and the cursor moving along the phrase text in accordance with how the user should repeat it are displayed on the monitor screen;
way-files are generated in accordance with repeated phrases and stored, according to the order of repeating them, in the forming acoustic base of the target speaker;
the program-controlled electronic information processing device controls a rate of a repeated phrase and its loudness;
a conversion function file is formed from the WAV-files stored in the target speaker acoustic base and WAV-files of the acoustic teaching base;
the parametric files of the acoustic base of initial audio materials are converted and transformed into a WAV-file for storing it in the forming acoustic base of converted audio materials and providing the user with data on converted audio materials on the monitor screen by using the conversion function file.

Thus, the claimed method and apparatus enable to improve quality of carrying out the teaching phase, improve match of the user's voice (that of the target speaker) in a converted speech signal due to improving accuracy, intelligibility and recognizability of the user's voice, ensure the possibility of carrying the teaching phase for a particular audio material only once and using this data, as obtained at the teaching phase, for re-sounding of other audio materials.

The method for re-sounding of audio materials and apparatus for implementing it are industrially applicable in program-controlled electronic devices for information processing during speech synthesis.

1. A method for re-vocalizing of audio materials, consisting in that wherein an acoustic base of initial audio materials and an acoustic teaching base comprising comprise audio files of teaching phrases of a speaker, and wherein a corresponding acoustic base of initial audio materials are formed in a program-controlled electronic information processing device, the method comprising the steps of:
transmitting; data from the acoustic base of initial audio materials for displaying a list of initial audio materials on the monitor screen;
after the user selects at least one audio material from the list of the acoustic base of initial audio materials, transmitting data on that audio material transmitted for storing in the random-access memory of the program-controlled electronic information processing device, wherein respective audio files containing teaching phrases of the speaker corresponding to the selected audio material are selected from the acoustic teaching base, which the audio files being transformed into audio phrases for display to the user;
repeating the audio phrases by the user into the microphone;
generating audio files in accordance with repeated phrases, which files are stored, in the order of repeating the phrases, in the formed acoustic base of the target speaker;
forming a conversion function file; and
converting and transforming the files of the acoustic base of initial audio materials into an audio file for storing in the formed acoustic base of converted audio materials and for providing the user with data on the converted audio materials on the monitor screen by using the conversion function file.

2. A method according to claim 1, wherein, if a remote server or computer, which functions in the multi-user mode, is used as the program-controlled electronic information processing device, the user should be registered.

3. A method according to claim 1, wherein, before the user repeats audio phrases into a microphone, background noise is recorded, this record is stored as an audio file in the target speaker acoustic base, and the program-controlled electronic information processing device reduces that background noise.

4. A method according to claim 1, wherein, when forming the target speaker acoustic base, the program-controlled electronic information processing device monitors a rate of a phrase repeated by the user and its loudness.

5. A method according to claim 1, wherein, when monitoring a rate of a repeated phrase, the program-controlled electronic information processing device filters a digital RAW-stream corresponding to the repeated phrase, calculates instantaneous energy and smoothes results of instantaneous energy calculation, compares a smoothed value of average energy to a pre-set threshold value, counts an average duration of silence intervals in the audio file, and program-controlled electronic information processing device decides whether this speech rate corresponds to the standard one.

6. A method according to claim 1, wherein, when monitoring a rate of a repeated phrase, the program-controlled electronic information processing device evaluates syllabic segments durations; for this a speech signal of the repeated phrase is normalized, filtered, detected; envelope signals of the repeated phrase are multiplied, differentiated; the obtained signal of the repeated phrase is compared to threshold voltages; and a logic signal is separated that corresponds to the presence of a syllabic segment; duration of the syllabic segment is calculated; and then the program-controlled electronic information processing device decides whether this speech rate corresponds to the standard one.

7. A method according to claim 1, wherein, when monitoring loudness of a repeated phrase, a lower limit of the loudness range and the upper limit of the loudness range are set, loudness of a repeated phrase is compared to the loudness range limits, and if loudness of a repeated phrase is beyond the said range limits, the program-controlled electronic information processing device displays a warning on violating loudness of the repeated phrase on the monitor screen.

8. A method according to claim 1, wherein, when forming the acoustic base of initial audio materials, parametric files are used, and when forming the acoustic teaching base WAV-files are used. Any files containing an audio stream may be used instead of said parametric files.

9. A method according to claim 1, wherein audio phrases are transmitted to the sound playback device for displaying to the user.

10. A method according to claim 1, wherein the process of repeating audio phrases by the user the text of a phrase to be repeated and the cursor moving along the phrase text in accordance with how the user should repeat it are displayed on the monitor screen.

11. A method according to claim 1, wherein, after storing audio files in the target speaker acoustic base and audio files in the acoustic teaching base the program-controlled electronic information processing device normalizes said audio files, performs their cutting-off and noise reduction, and monitors compliance of the repeated text and the displayed text of the repeated phrase.

12. The apparatus for re-vocalizing audio materials, comprising:
the control unit,
the unit for selection of audio materials,
the acoustic base of initial audio materials,
the acoustic base of the target speaker,
the teaching unit,
the phrase playback unit,
the phrase recording unit,
the acoustic teaching base,
the conversion unit,
the conversion function base,
the acoustic base of converted audio materials,
the unit for displaying conversion results,
the monitor,
the keyboard,
the pointing device,
the microphone,
the sound playback device,
the keyboard output being connected to the first input of the control unit, to the first input of the audio material selection unit, and to the first input of the unit for displaying conversion results,
the pointing device output being connected to the second input of the control unit, to the second input of the audio material selection unit, and to the second input of the unit for displaying conversion results,
the monitor input being connected to the output of the audio material selection unit, to the output of the teaching unit, to the first output of the unit for phrase playback, to the output of the phrase recording unit, to the output of the conversion unit, to the output of the unit for displaying conversion results,
the input of the sound playback device being connected to the second output of the phrase playback unit,
the microphone output being connected to the input of the phrase recording unit,
the first input/output of the control unit being connected to the first input/output of the audio material selection unit,
the second input/output of the control unit being connected to the first input/output of the target speaker acoustic base,
the third input/output of the control unit being connected to the first input/output of the teaching unit,
the fourth input/output of the control unit being connected to the first input/output of the conversion unit,
the fifth input/output of the control unit being connected to the first input/output of the unit for displaying conversion results,
the second input/output of the audio material selection unit being connected to the first input/output of the acoustic base of initial audio materials, and
the second input/output of the acoustic base of initial audio materials being connected to the fourth input/output of the conversion unit,
the second input/output of the target speaker acoustic base being connected to the first input/output of the phrase recording unit, and
the second input/output of the phrase recording unit being connected to the third input/output of the teaching unit,
the second input/output of the teaching unit being connected to the first input/output of the unit for phrase playback, and
the second input/output of the unit for phrase playback being connected to the input/output of the acoustic teaching base,
the fourth input/output of the teaching unit being connected to the first input/output of the conversion function base,
the second input/output of the base being connected to the second input/output of the conversion unit,
the third input/output of the conversion unit being connected to the second input/output of the acoustic base of converted audio materials, and
the first input/output of the acoustic base of converted audio materials being connected to the second input/output of the unit for displaying conversion results.

13. An apparatus according to claim 12, wherein an authorization/registration unit and a base of registered users are added,
wherein the keyboard output is connected to the first input of the authorization/registration unit, and
wherein the pointing device output is connected to the second input of the authorization/registration unit,
wherein the monitor input is connected to the output of the authorization/registration unit,
wherein the sixth input/output of the control unit is connected to the first input/output of the authorization/registration unit, and
wherein the second input/output of the authorization/registration unit is connected to the input/output of the base of registered users.
